(19) United States
(12) Patent Application Publication
(10) Pub. No.: US 2023/0094736 A1
(43) Pub. Date: Mar. 30, 2023

(54) LASER BEAM SHAPING APPARATUS

(71) Applicants: Syndiant Inc., Dallas, TX (US); XDMicro(Zhongshan) Optoelectronic Semiconductor Co., Ltd., Zhongshan City (CN)

(72) Inventors: Sheng Hsiung CHAN, Zhubei City (TW); Yu Ta Chung, Hsinchu County (TW)

(21) Appl. No.: 17/547,433

(22) Filed: Dec. 10, 2021

(30) Foreign Application Priority Data
Sep. 30, 2021 (TW) 110136557

(51) Int. Cl. G02B 19/00; G02B 27/09; G02B 27/12; G02B 27/30

(52) U.S. Cl. CPC G02B 19/0052; G02B 27/0977; G02B 27/12; G02B 27/30

(57) ABSTRACT

The present invention relates to a laser beam shaping apparatus, which comprises a non-rotational symmetrical semiconductor laser source, a collimating mirror and a shaping apparatus. Therefore, the profile of laser light can be shaped, and the intensity of laser light with Gaussian distribution can be adjusted without designing for a specific wavelength, and the luminous efficiency will not be reduced accordingly. In addition, since the present invention uses planar film-coated elements, it has low requirements on size and installation accuracy, which can not only effectively reduce the cost of the apparatus, but also avoid problems of aberration or deformation at the same time.

This application claims priority to Taiwan Patent Application No. 110136557 filed on Sep. 30, 2021.

### CROSS-REFERENCES TO RELATED APPLICATIONS

Not applicable.

### BACKGROUND OF THE INVENTION

### Field of the Invention

The present invention relates to a laser beam shaping apparatus, and in particular, relates to a shaping apparatus which is capable of changing the profile and intensity distribution of laser light with elliptical profile and Gaussian intensity distribution simply by using a planar film-coated element.

### Descriptions of the Related Art

Please refer to FIG. 1 for a conventional semiconductor laser source, in which the divergence angle of laser light generated by the semiconductor laser source is different for transverse electric wave and transverse magnetic wave, so the profile of the laser light is elliptical and the intensity distribution thereof is Gaussian distribution.

However, in the application of laser light, it is usually necessary to use circular laser light or laser light with a more symmetrical profile to cover a larger area at the same time. Therefore, in the traditional optical system, for this kind of non-rotational symmetrical semiconductor laser sources, in addition to using a rotational symmetrical collimating mirror to obtain collimated laser light, a non-rotational symmetrical optical element for shaping (such as a cylindrical mirror or prism) is used in combination to shape the light generated by the semiconductor laser source so as to change the profile of light, thereby obtaining light that is circular or has a more symmetrical profile and has a larger coverage area. Alternatively, an unconventional optical element (such as a diffractive optical element) that can shape the light and change the intensity distribution thereof at the same time is used in combination to shape the light generated by the semiconductor laser source, and change the profile and intensity distribution of the light to obtain light that is circular or has a more symmetrical profile and has appropriate intensity distribution.

In order to obtain circular light or light with a more symmetrical profile, some apparatuses among the traditional laser beam shaping apparatuses use two cylinder lenses. However, the laser beam shaping apparatus using cylindrical mirrors is prone to aberration or deformation, which leads to poor collimation effect of the shaped laser light. Moreover, the cylinder lenses belong to non-rotational symmetrical optical elements, and the price thereof is higher than that of rotational symmetrical elements, and it is impossible to flatten the intensity distribution of the laser light with Gaussian distribution. That is, with this conventional apparatus, although elliptical light can be shaped into circular light or light with a more symmetrical profile, the intensity distribution of the shaped laser light still presents Gaussian distribution and cannot be adjusted.

In order to obtain circular light or light with a more symmetrical profile, some apparatuses among the traditional laser beam shaping apparatuses use two prisms. However, since prisms belong to non-rotational symmetrical optical elements, the price thereof is higher than that of rotational symmetrical elements, and it is impossible to flatten the intensity distribution of laser light with Gaussian distribution. That is, with this conventional apparatus, although elliptical light can be shaped into circular light or light with a more symmetrical profile, the intensity distribution of the shaped laser light still presents Gaussian distribution and cannot be adjusted.

None of the above-mentioned conventional laser beam shaping apparatuses can adjust the intensity distribution of laser light with Gaussian distribution.

Therefore, in order to obtain circular light or light with a more symmetrical profile and meanwhile adjust the intensity distribution of laser light with Gaussian distribution, some apparatuses among the traditional laser beam shaping apparatuses adopt diffractive optical elements. In order to make the laser light diffract smoothly, the shaping apparatus using this conventional technology must be designed for a specific wavelength, and the diffractive optical elements must adopt a special process, which is expensive and the luminous efficiency is inferior to that of the aforementioned geometrical optical apparatuses.

As can be seen from the above description, the traditional laser beam shaping apparatus using non-rotational symmetrical elements is incapable of adjusting the intensity distribution of laser light, and need to calibrate the optical axis first in use, and there are still problems such as aberration or deformation and high cost after calibration. Although the traditional laser beam shaping apparatus using unconventional optical elements can adjust the intensity distribution of laser light, it still needs to calibrate the optical axis first in use, and there are still problems such as aberration or deformation, low luminous efficiency and high cost after calibration.

Accordingly, an urgent need exists in the art to provide a laser beam shaping apparatus that can solve the above problems.

### SUMMARY OF THE INVENTION

The present invention provides a laser beam shaping apparatus, and the laser beam shaping apparatus uses planar film-coated elements, can effectively reduce the apparatus cost, has low requirements on size and installation accuracy, can avoid problems of aberration or deformation existing in the prior art, can shape the profile of laser light, and can further adjust the intensity of laser light with Gaussian distribution without designing for a specific wavelength, and will not reduce the luminous efficiency accordingly.

For example, when the present invention is applied to a micro-projection display optical system, the circular light or light with a more symmetrical profile can achieve a larger light coverage area than the unshaped elliptical light, and the laser light can be uniformly incident on an array of uniform light-using apparatuses since the intensity of the laser light with Gaussian distribution can be adjusted.

In order to achieve the above objective, the present invention provides a laser beam shaping apparatus, which comprises: a non-rotational symmetrical semiconductor laser source, being configured to generate laser light, wherein the profile of the laser light is elliptical and the intensity distribution thereof is Gaussian distribution; a collimating mirror, being disposed on a laser light propagating path for generating collimated laser light; a shaping apparatus, being composed of one or more beam splitters and a reflecting mirror, being disposed on a collimated laser light passing path to shape the laser light and adjust the intensity distribution of the laser light.

### BRIEF DESCRIPTION OF THE DRAWINGS

FIG. 1 is a schematic view of the profile and intensity distribution of a conventional non-rotational symmetrical semiconductor laser source;

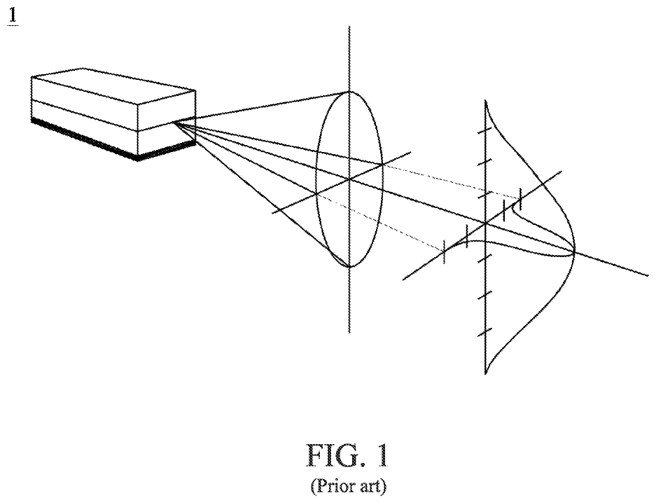

FIG. 2 is a schematic structural configuration view of a first embodiment of the present invention; and

FIG. 3 is a schematic structural configuration view of a second embodiment of the present invention.

### DESCRIPTION OF THE PREFERRED EMBODIMENT

It shall be noted first, possible embodiments of the present invention are illustrated below simply with examples, and these examples are not intended to limit the scope to be claimed in the present invention.

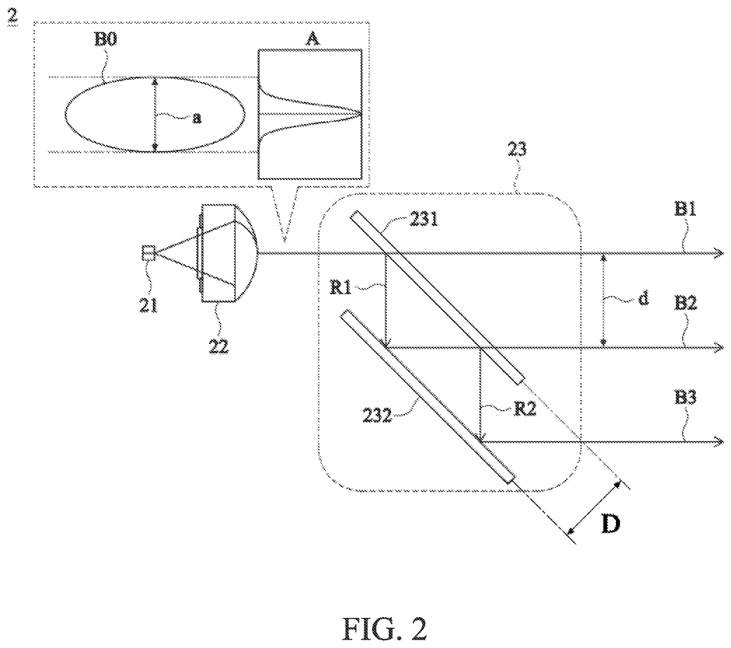

Please refer to FIG. 2, which is a schematic structural configuration view of a first embodiment of the present invention. In the first embodiment, the laser beam shaping apparatus 2 comprises a non-rotational symmetrical semiconductor laser source 21, a collimating mirror 22 and a shaping apparatus 23, wherein the shaping apparatus 23 is composed of a beam splitter 231 and a reflecting mirror 232 which are arranged in parallel.

The non-rotational symmetrical semiconductor laser source 21 may generate laser light with an elliptical profile and Gaussian intensity distribution, and the laser light is collimated by the collimating mirror 22 to become a collimated laser light B0, which has a narrow side width of a, a maximum intensity of A and Gaussian intensity distribution. When the collimated laser light B0 is incident onto the beam splitter 231 in which the transmittance is T, the reflectance is R and T+R=1 in the shaping apparatus 23, the collimated laser light B0 is split by the beam splitter 231 into a first light B1 which penetrates the beam splitter 231 and a first reflected light R1 which is reflected by the beam splitter 231, wherein the first light B1 has an elliptical profile, a narrow side width of a, a maximum intensity of A×T and Gaussian intensity distribution. The first reflected light R1 is then incident on the reflecting mirror 232 with reflectance of M and reflected, and then enters the beam splitter 231 and is split by the beam splitter 231 into a second light B2 that penetrates the beam splitter 231 and a second reflected light R2 that is reflected by the beam splitter 231, wherein the second light B2 has an elliptical profile, a narrow side width of a, a maximum intensity of A×R×M×T and Gaussian intensity distribution. The second reflected light R2 continues to enter the reflecting mirror 232 and is reflected as a third light B3, wherein the third light B3 has an elliptical profile, a narrow side width of a, a maximum intensity of A×R×M×R×M and Gaussian intensity distribution. For example, when the transmittance T of the beam splitter 231 is set to be 0.5, the reflectance R of the beam splitter 231 are set to be 0.5 and the reflectance M of the reflecting mirror is equal to 1, the intensity of the first light B1 is 50% of the collimated laser light B0, the intensity of the second light B2 is 25% of the collimated laser light B0, and the intensity of the third light B3 is 25% of the collimated laser light B0. As another example, when the transmittance T of the beam splitter 231 is set to be 0.38, the reflectance R of the beam splitter 231 is set to be 0.62, and the reflectance M of the reflecting mirror is equal to 1, the intensity of the first light B1 is 38% of the collimated laser light B0, the intensity of the second light B2 is 23.56% of the collimated laser light B0, and the intensity of the second light B2 is 38.44% of the collimated laser light B0.

The distance between the beam splitter 231 and the reflecting mirror 232 in the shaping apparatus 23 is D, and the distance between the first light B1, the second light B2 and the third light B3 generated after the collimated laser light B0 passes through the shaping apparatus 23 is d, wherein d=\sqrt{2}D. By adjusting the distance D between the beam splitter 231 and the reflecting mirror 232 in the shaping apparatus 23 to make the distance d between the first light B1, the second light B2 and the third light B3 smaller than the width a of the first light B1, the second light B2 and the third light B3, a circular light or light with a more symmetrical profile that is generated by converging the first light B1, the second light B2 and the third light B3 can be obtained, and the intensity distribution of the light is obtained by superimposing the intensity distributions of the first light B1, the second light B2 and the third light B3, thereby achieving the purpose of shaping the laser light and adjusting the intensity distribution thereof at the same time.

In this embodiment, the transmittance T and reflectance R of the beam splitter 231 can be set in a fixed ratio, for example, the transmittance T of the beam splitter 231 is set to be 0.5, the reflectance R of the beam splitter 231 is set to be 0.5, or the transmittance T of the beam splitter 231 is set to be 0.38, the reflectance R of the beam splitter 231 is set to be 0.62, or they can be set in a gradient ratio, thereby achieving the purpose of shaping the laser light and adjusting the intensity distribution thereof at the same time.

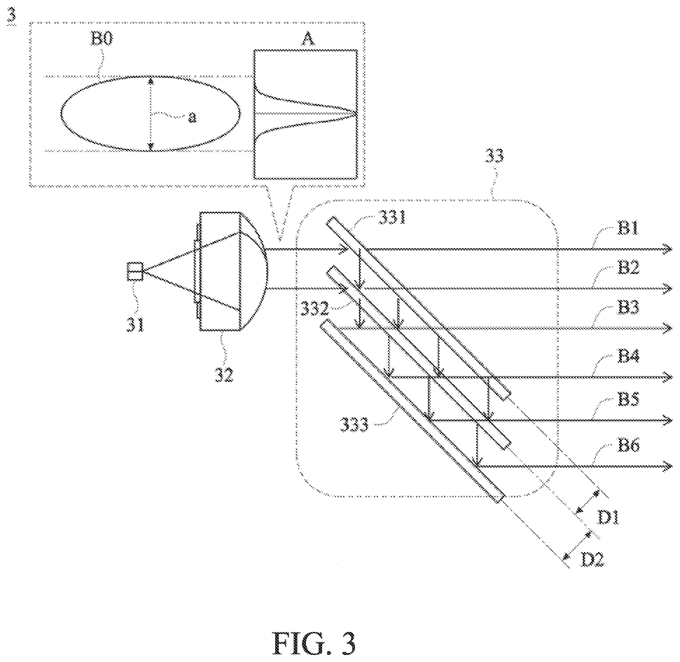

Please refer to FIG. 3, which is a schematic structural configuration view of a second embodiment of the present invention. In the second embodiment, the laser beam shaping apparatus 3 comprises an non-rotational symmetrical semiconductor laser source 31, a collimating mirror 32 and a shaping apparatus 33, wherein the shaping apparatus 33 is composed of a first beam splitter 331, a second beam splitter 332 and a reflecting mirror 333, and the first beam splitter 331, the second beam splitter 332 and the reflecting mirror 333 are arranged in parallel. The transmittance of the first beam splitter is T₁, the reflectance thereof is R₁, and T₁+R₁=1, the transmittance of the second beam splitter 332 is T₂, the reflectance thereof is R₂, and T₂+R₂=1, and the reflectance of the reflecting mirror 333 is M.

The non-rotational symmetrical semiconductor laser source 31 may generate laser light with an elliptical profile and Gaussian intensity distribution, and the laser light is collimated by the collimating mirror 32 to become a collimated laser light B0, which has a narrow side width of a, a maximum intensity of A and Gaussian intensity distribution. After the laser light B0 passes through the shaping apparatus 33, a plurality of light beams, e.g., a first light B1 to a sixth light B6, can be generated, wherein the profiles of the first light B1 to the sixth light B6 are all elliptical, the narrow side widths are all a and the intensity distribution is Gaussian distribution, but the intensity of individual light depends on the transmittance and reflectance of the light passing through the first beam splitter 331, the second beam splitter 332 and the reflecting mirror 333.

In the shaping apparatus 33, the distance between the first beam splitter 331 and the second beam splitter 332 is D1, and the distance between the second beam splitter 332 and the reflecting mirror 333 is D2. By adjusting the distance of D1, all the collimated laser light B0 can be incident on the first beam splitter 331, or part of the collimated laser light B0 can be incident on the first beam splitter 331 while the remaining collimated laser light B0 is incident on the second beam splitter 332; and by adjusting the distances of D1 and D2 in the shaping apparatus 33, the distance between the first light B1 to the sixth light B6 can be made smaller than the width a of the first light B1 to the sixth light B6. In this way, a circular light or light with a more symmetrical profile generated by converging the first light B1 to the sixth light B6 can be obtained, and the intensity distribution of the light is generated by superimposing the intensity distribution of the first light B1 to the sixth light B6, thereby achieving the purpose of shaping the laser light and adjusting the intensity distribution thereof at the same time. Since the setting of the distances of D1 and D2 can be adjusted and can be the same or different, the distance between the first light B1 to the sixth light B6 may be the same or different.

In this embodiment, the transmittance T₁ and reflectance R₁ of the first beam splitter 331 and the transmittance T₂ and reflectance R₂ of the second beam splitter 332 can be set at the same or different fixed ratios, or at the same or different gradient ratios, so as to achieve the purpose of shaping the laser light and adjusting the intensity distribution thereof at the same time.

In a third embodiment of the present invention, except for the shaping apparatus, other settings are the same as those in the second embodiment. The shaping apparatus in the third embodiment is provided with more than three beam splitters and a reflecting mirror, wherein the distance between the beam splitters can be adjusted so that all the collimated laser light can be incident on the first beam splitter or can be divided into several different parts to be incident on all the beam splitters, and the distance between the more than three beam splitters and a reflecting mirror in the shaping apparatus can be adjusted so as to make the distance between the light beams generated by the shaping apparatus smaller than the narrow side width a of the light, and obtain a circular light or a light with a more symmetrical profile generated by converging all the light generated by the shaping apparatus and adjust the intensity distribution of the light, thereby achieving the purpose of shaping the laser light and adjusting the intensity distribution thereof at the same time.

The transmittance and reflectance of the beam splitter in this embodiment can be set at the same or different fixed ratios, or at the same or different gradient ratios, so as to achieve the purpose of shaping the laser light and adjusting the intensity distribution at the same time.

To sum up, the laser beam shaping apparatus of the present invention uses planar film-coated elements instead of non-rotational symmetrical elements or non-conventional optical elements for shaping and can adjust the intensity distribution of laser light, which not only can effectively reduce the cost, but also can avoid the problems of aberration or deformation existing in the prior art, and it even does not need to design for a specific wavelength and can maintain high luminous efficiency.

When the present invention is applied to a micro-projection display optical system, the laser light that is circular or has a more symmetrical profile after being shaped has a larger coverage area, and the laser light can be uniformly incident on an array of uniform light-using apparatuses.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A laser beam shaping apparatus, comprising:
a non-rotational symmetrical semiconductor laser source, being configured to generate laser light, wherein the profile of the laser light is elliptical and the intensity distribution thereof is Gaussian distribution;
a collimating mirror, being disposed on a laser light passing path for generating collimated laser light;
a shaping apparatus, being composed of a beam splitter and a reflecting mirror which are arranged in parallel, and the transmittance and reflectance of the beam splitter being set in a fixed ratio, and the beam splitter being disposed on a collimated laser light passing path, the collimated laser light passing through the shaping apparatus to generate a plurality of laser beams, wherein the distance between the beam splitter and the reflecting mirror is capable of being adjusted arbitrarily within the range of overlapping the laser beams generated by the shaping apparatus, so as to change the profile and intensity distribution of the laser light.

2. The laser beam shaping apparatus of claim 1, wherein the transmittance and reflectance of the beam splitter are set in a gradient ratio.

3. A laser beam shaping apparatus, comprising:
a non-rotational symmetrical semiconductor laser source, being configured to generate laser light, wherein the profile of the laser light is elliptical and the intensity distribution thereof is Gaussian distribution;
a collimating mirror, being disposed on a laser light passing path for generating collimated laser light;
a shaping apparatus, being composed of a first beam splitter, a second beam splitter and a reflecting mirror which are arranged in parallel, and the transmittance and reflectance of the first beam splitter and the second beam splitter being set in a fixed ratio, and the beam splitters being disposed on a collimated laser light passing path so that all the collimated laser light is incident onto the first beam splitter, the collimated laser light passing through the shaping apparatus to generate a plurality of laser beams, wherein the distance between the first beam splitter, the second beam splitter and a reflecting mirror is capable of being adjusted arbitrarily within the range of overlapping the laser beams generated by the shaping apparatus, so as to change the profile and intensity distribution of the laser light.

4. The laser beam shaping apparatus of claim 3, wherein the transmittance and reflectance of the beam splitter are set in a gradient ratio.

5. The laser beam shaping apparatus of claim 3, wherein the collimated laser light is incident onto the first beam splitter and the second beam splitter respectively.

6. The laser beam shaping apparatus of claim 5, wherein the transmittance and reflectance of the beam splitter are set in a gradient ratio.

7. A laser beam shaping apparatus, comprising:
a non-rotational symmetrical semiconductor laser source, being configured to generate laser light, wherein the profile of the laser light is elliptical and the intensity distribution thereof is Gaussian distribution;
a collimating mirror, being disposed on a laser light passing path for generating collimated laser light;
a shaping apparatus, being composed of more than three beam splitters and a reflecting mirror which are arranged in parallel, and the transmittance and reflectance of the beam splitters being set in a fixed ratio, and the beam splitters being disposed on a collimated laser light passing path so that all the collimated laser light is incident onto the first beam splitter, the collimated laser light passing through the shaping apparatus to generate a plurality of laser beams, wherein the distance between the beam splitters and a reflecting mirror is capable of being adjusted arbitrarily within the range of overlapping the laser beams generated by the shaping apparatus, so as to change the profile and intensity distribution of the laser light.

8. The laser beam shaping apparatus of claim 7, wherein the transmittance and reflectance of the beam splitter are set in a gradient ratio.

9. The laser beam shaping apparatus of claim 7, wherein the collimated laser light is incident onto a plurality of beam splitters respectively.

10. The laser beam shaping apparatus of claim 9, wherein the transmittance and reflectance of the beam splitter are set in a gradient ratio.
